(19) United States
(12) Patent Application Publication
(10) Pub. No.: US 2024/0326390 A1
(43) Pub. Date: Oct. 3, 2024

(54) HEAT SHRINKABLE FILM AND MANUFACTURING METHOD THEREOF

(71) Applicant: GUNZE LIMITED, Kyoto (JP)

(72) Inventors: Tatsuya KIBAYASHI, Shiga (JP); Tsukasa NAKAO, Shiga (JP)

(73) Assignee: GUNZE LIMITED, Kyoto (JP)

(21) Appl. No.: 18/294,022

(22) PCT Filed: Aug. 3, 2022
(86) PCT No.: PCT/JP2022/029831

§ 371 Date: Jan. 31, 2024

(30) Foreign Application Priority Data
Aug. 5, 2021 (JP) 2021-128995

(51) Int. Cl. B32B 27/08; B29B 17/02; B29C 48/00; B29C 48/08; B29C 48/21; B29K 25/00; B29K 67/00; B29K 105/02; B29K 105/26; B32B 27/30; B32B 27/36

(52) U.S. Cl. CPC B32B 27/08; B29C 48/022; B32B 27/302; B32B 27/308; B32B 27/36; B29B 17/02; B29B 2017/0203; B29C 48/08; B29C 48/21; B29K 2025/06; B29K 2067/00; B29K 2105/02; B29K 2105/26; B32B 2250/03; B32B 2250/24; B32B 2250/40; B32B 2270/00; B32B 2272/00; B32B 2307/736; B32B 2553/00

(57) ABSTRACT

A manufacturing method for a heat shrinkable film includes: preparing a packaging material that includes film labels having a resin layer mainly contains thermoplastic resin, and a printed layer; recovering first and second recycled raw materials from the resin layer; and forming a resin film with a core layer including the recycled raw materials and a surface layer layered onto the core layer and includes thermoplastic resin. Recovering the recycled raw materials includes: forming, into individual pieces, the packaging material and/or the resin layer from which the printed layer has been removed; and separating the printed layer from the packaging material and/or pieces of the packaging material to obtain the resin layer from which the printed layer has been removed and/or pieces of the resin layer from which the printed layer has been removed. One of the recycled raw materials is polyester-based resin, and the other is polystyrene-based resin.

### FIELD OF INVENTION

The present invention relates to a heat shrinkable film and a manufacturing method thereof.

### BACKGROUND ART

Patent Literature 1 discloses a heat shrinkable film manufacturing method using recycled raw materials. Heat shrinkable films manufactured by this manufacturing method include virgin raw materials and recycled raw materials. In these heat shrinkable films, to suppress deterioration of various physical properties such as optical properties, the same raw materials, for example, raw materials mainly containing polyester resin, are used as the virgin raw materials and recycled raw materials.

### CITATION LIST

### Patent Literature

Japanese Patent Laid-Open Publication No. H6-047810

### SUMMARY OF INVENTION

### Technical Problem

An object of the present invention is to provide high-quality heat shrinkable films using a recycled raw material and provide a manufacturing method thereof.

### Solution to Problem

A manufacturing method for a heat shrinkable film according to a first aspect of the present invention includes the followings:
preparing packaging materials including a plurality of film labels having a resin layer including thermoplastic resin as a main component and a print layer:
recovering, from the resin layer, a first recycled raw material and a second recycled raw material that is different from the first recycled raw material; and
forming a resin-based film having at least a core layer including at least the first recycled raw material and the second recycled raw material and a surface layer layered on the core layer and comprising thermoplastic resin.

The recovering the first recycled raw material and the second recycled raw material includes: cutting at least either the packaging materials or the resin layer from which the print layer has been removed into pieces; and separating the print layer from at least either the packaging materials or the pieces of the packaging materials, thereby obtaining at least either the resin layer from which the print layer has been removed or the pieces of the resin layer from which the print layer has been removed. One of the first and second recycled raw materials is polyester-based resin and the other is polystyrene-based resin.

A manufacturing method for a heat shrinkable film according to a second aspect of the present invention is the manufacturing method for a heat shrinkable film according to the first aspect, wherein the forming the resin-based film includes forming the surface layer mainly including a virgin raw material of thermoplastic resin, and the thermoplastic resin is polyester-based resin or polystyrene-based resin.

A manufacturing method for a heat shrinkable film according to a third aspect of the present invention is the manufacturing method for a heat shrinkable film according to the first or second aspect, further including recovering the polystyrene-based resin from manufacturing intermediate materials other than the packaging materials, wherein the forming the resin-based film includes forming the core layer including the recovered polystyrene-based resin.

A heat shrinkable film according to a fourth aspect of the present invention includes a core layer and a surface layer. The core layer includes at least a first recycled raw material, a second recycled raw material that is different from the first recycled raw material, and an acrylic ester-based resin. The surface layer is layered on at least one surface of the core layer and includes thermoplastic resin. The first recycled raw material is obtained from packaging materials serving as starting materials and including a plurality of film labels having a resin layer including thermoplastic resin as a main component and a print layer. One of the first and second recycled raw materials is polyester-based resin, and the other is polystyrene-based resin.

### Advantageous Effects of Invention

According to the manufacturing method for a heat shrinkable film relating to the present invention, the starting material in which polystyrene-based resin and polyester-based resin are mixed can be directly used as a recycled raw material. Further, according to the heat shrinkable film according to the present invention, the quality is high even when the above-described recycled raw material is used.

### BRIEF DESCRIPTION OF DRAWINGS

FIG. 1 is a cross-sectional diagram illustrating a heat shrinkable film of a first embodiment.

FIG. 2 is a cross-sectional diagram illustrating a heat shrinkable film of a second embodiment.

FIG. 3 is a flowchart illustrating an example of a heat shrinkable film manufacturing method.

### DESCRIPTION OF EMBODIMENTS

Hereinafter, a heat shrinkable film according to an embodiment of the present invention will be described with reference to attached drawings, and then a manufacturing method for a heat shrinkable film according to an embodiment will be described.

### 1. First Embodiment

### <1-1. Configuration of Heat Shrinkable Film>

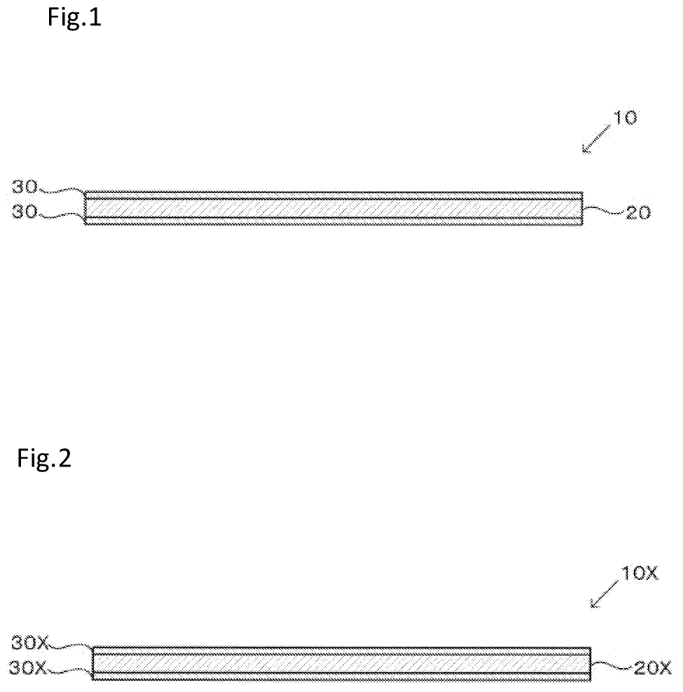

FIG. 1 is a cross-sectional diagram illustrating an exemplary layer configuration of a heat shrinkable film 10 of the first embodiment. The heat shrinkable film 10 of the present embodiment is used as a base film of a heat shrinkable film label that is, for example, attached to a container such as a plastic bottle or a metal can. The heat shrinkable film 10 includes a core layer 20 and surface layers 30 layered on the core layer 20. The core layer 20 of the heat shrinkable film 10 of the present embodiment is configured so as to include recycled raw material that is a raw material different from virgin raw material. In general, when a recycled raw material that is different from a virgin raw material is used for heat shrinkable films, film surfaces tend to be roughened and glossiness, printing characteristics, or the like tend to deteriorate. The heat shrinkable film 10 of the present embodiment is configured in such a manner that, even when the core layer 20 is configured to include a recycled raw material that is a raw material different from a virgin raw material, the film surfaces are less likely to be roughened while high quality is maintained.

For example, the overall thickness of the heat shrinkable film 10 is preferably equal to or greater than 10 μm, more preferably equal to or greater than 12 μm, and further preferably equal to or greater than 15 μm, and is preferably equal to or less than 70 μm, more preferably equal to or less than 65 μm, and further preferably equal to or less than 60 μm. That is, the overall thickness of the heat shrinkable film 10 is preferably not less than 10 μm and not greater than 70 μm, more preferably not less than 12 μm and not greater than 65 μm, and further preferably not less than 15 μm and not greater than 60 μm. When the overall thickness of the heat shrinkable multilayer film is within the above-described range, excellent heat shrinkable properties, excellent converting properties such as printing and center sealing, or excellent properties for attaching to a container can be obtained.

### <1-2. Core Layer>

The core layer 20 includes at least a recycled raw material and can also include a virgin raw material. As the virgin raw material for the core layer 20, a known thermoplastic resin can be appropriately selected and used. Examples of the virgin raw material for the core layer 20 include polyamide-based resin, polyester-based resin, polyethylene-based resin, polyvinyl alcohol resin, polypropylene-based resin, polystyrene-based resin, and cyclic olefin-based resin. From the viewpoint of heat shrinkable properties, the virgin raw material for the core layer 20 is preferably polystyrene-based resin, polyester-based resin, or polypropylene-based resin. In the present embodiment, the virgin raw material for the core layer 20 is polystyrene-based resin. From the viewpoint of exhibiting heat shrinkable properties, for example, styrene-butadiene copolymer, styrene-isoprene copolymer, styrene-isoprene-butadiene copolymer, or styrene-acrylic copolymer can be used as the polystyrene-based resin. For example, a resin obtainable by polycondensation of dicarboxylic acid components and diol components can be used as the polyester-based resin. The heat shrinkable film 10, when including the above-described polystyrene-based resin as the virgin raw material for the core layer 20, can suppress heat shrinkage properties and shape followability during heat shrinkage from varying at low temperatures.

The above-described virgin raw material may include a recycled raw material from which fluff and re-pellet have been removed, which can be obtained through a so-called mechanical recycling from thermoplastic resins contained in film labels or the like. Examples of such recycled raw material include a recycled raw material obtained through chemical recycling, and more specifically, include raw material that is recycled from monomers obtained by chemically decomposing thermoplastic resins contained in molded products. Further, the above-described virgin raw material may include thermoplastic resin raw materials derived from biomass (and not so-called mechanical recycled). Utilizing these environmental-load reducing raw materials as the virgin raw material, in addition to the recycled raw material described below, can provide the heat shrinkable film 10 in which thermoplastic resin components are composed of 100% environmental-load reducing raw material. The virgin raw material is not limited to the above-described environmental-load reducing raw material and can include a petroleum-derived thermoplastic resin raw material.

Examples of the recycled raw material for the core layer 20 include one or more thermoplastic resins recovered from the followings: packaging materials including film labels having print layers recovered from the market, which have been subjected to deinking treatment: film labels that have been downgraded during printing processes and subjected to deinking treatment; and scrap materials generated during film manufacturing processes including manufactured selvedges, slit selvedges, and non-standard products, so on. Further, one or more thermoplastic resins recovered from resin compositions that have not been formed into films, such as lumps and strand waste of resin compositions generated in molding devices during film manufacturing processes, may be included. Hereinafter, deinked materials, scrap materials, and resin compositions generated in the above-described film label manufacturing processes will be collectively referred to as “manufacturing intermediate materials”. The recycled raw material for the core layer 20 of the present embodiment includes first recycled raw material and second recycled raw material different from the first recycled raw material. In the present embodiment, the first recycled raw material is polystyrene-based resin and the second recycled raw material is polyester-based resin. In the present embodiment, the difference in recycled raw materials is not limited to the difference in type between thermoplastic resins, and includes differences in Vicat softening temperature, glass transition point, copolymer composition, weight-average molecular weight, and the like of the thermoplastic resin, even in the case of no difference in type. From the viewpoint of further improving the quality of the heat shrinkable film 10, the first recycled raw material is preferably the same raw material as the virgin raw material for the core layer 20.

The above-described packaging materials may include an overcoat layer configured by an overcoat agent, in addition to the print layer. The overcoat agent is generally an acrylic ester-based resin and remains in trace amounts in the recycled raw materials subjected to the deinking treatment. Accordingly, the core layer 20 may include acrylic acid (methacrylic acid) ester-based resin derived from the overcoat agent, in addition to the recycled raw material. The proportion of the acrylic acid (methacrylic acid) ester-based resin to the entire 100 wt. % of the thermoplastic resin constituting the heat shrinkable film 10 is preferably equal to or less than 0.6 wt. %, more preferably equal to or less than 0.4 wt. %, and further preferably equal to or less than 0.2 wt. %.

Proportion RX of the recycled raw material in the entire thermoplastic resin of the core layer 20 is arbitrarily selectable. The proportion RX is preferably in a range not less than 2.5 wt. % and not greater than 100 wt. %.

Proportion RA of the second recycled raw material to the recycled raw material (first recycled raw material+second recycled raw material) in the entire thermoplastic resin of the core layer 20 is arbitrarily selectable. When the first recycled raw material is the same raw material as the virgin raw material for the core layer 20, from the viewpoint of improving the quality of the heat shrinkable film 10, the proportion RA is preferably equal to or less than 80 wt. %, more preferably equal to or less than 45 wt. %, and further preferably equal to or less than 15 wt. %.

For example, the thickness of the core layer 20 is preferably not less than 5 μm and not greater than 50 μm, and more preferably not less than 7 μm and not greater than 40 μm.

### <1-3. Surface Layer>

The surface layer 30 is layered on at least one surface of the core layer 20 via an adhesive layer, for example. In the present embodiment, the surface layer 30 is layered on both surfaces of the core layer 20. The surface layer 30 may be layered on only one surface of the core layer 20.

The surface layer 30 is configured solely by a virgin raw material that is different from the virgin raw material for the core layer 20. The virgin raw material for the surface layer 30 is arbitrarily selectable from thermoplastic resins exemplified as the virgin raw materials for the core layer 20, for example. In the present embodiment, the virgin raw material for the surface layer 30 is polyester-based resin. It should be noted that “substantially configured solely by the virgin raw material that is different from the virgin raw material for the core layer 20” means that the surface layer 30 includes recycled raw material in addition to the virgin raw material to the extent that surface roughness does not substantially occur. In other words, the surface layer 30 includes the virgin raw material different from the virgin raw material for the core layer 20 as a main component. When the surface layer 30 includes a recycled raw material, the recycled raw material for the surface layer 30 is preferably the same raw material as the virgin raw material for the surface layer 30. Further, the virgin raw material included in the surface layer 30 may include an environmental-load reducing raw material, like the core layer 20, and thermoplastic resin components of the surface layer 30 may be composed of 100% environmental-load reducing raw material.

When the surface layer 30 includes the above-described polyester-based resin as the virgin raw material, the proportion of the above-described polyester-based resin to the entire thermoplastic resin of the surface layer 30 is preferably equal to or greater than 85 wt. %, more preferably equal to or greater than 90 wt. %, and further preferably equal to or greater than 95 wt. %.

For example, the thickness of the surface layer 30 is preferably not less than 1 μm and not greater than 30 μm, more preferably not less than 2 μm and not greater than 20 μm, and further preferably not less than 3 μm and not greater than 10 μm.

The surface layer 30 may include an anti-blocking agent to exhibit ant-blocking performance. Either organic fine particles or inorganic fine particles can be used as the anti-blocking agent (anti-blocking fine particles). Organic fine particles such as acrylic resin fine particles, styrene-based resin fine particles, styrene-acrylic resin fine particles, urethane-based resin fine particles, silicone-based resin fine particles, and the like can be used as the organic fine particles. These may be crosslinked or may not be crosslinked, but being crosslinked is desirable to improve heat-resisting properties of the fine particles. Among them, acrylic resin fine particles are preferable from the viewpoint of compatibility with the above-described styrene-based resin, and polymethyl methacrylate-based crosslinked fine particles are more preferable. Further, among the above-described organic fine particles, commercially available products include, for example, TECHPOLYMER (manufactured by Sekisui Kasei Co., Ltd.), FINE SPHERE (manufactured by Nippon Paint Co., Ltd.), GANTZ PEARL (manufactured by Aica Kogyo Company, Limited), ART PEARL (manufactured by Negami Chemical Industrial Co., Ltd.) and the like.

### <1-4. Functions and Effects of Heat Shrinkable Film>

According to the heat shrinkable film 10, the surface of the core layer 20 including the recycled raw material is covered with the surface layer 30 substantially configured solely by the virgin raw material (in other words, the virgin raw material is a main component). Therefore, optical properties and the like are unlikely to deteriorate. Accordingly, even in the case of the core layer 20 using the recycled raw material that is different from the virgin raw material, the quality of the heat shrinkable film 10 is high.

Further, since the recycled raw material for the core layer 20 includes the first recycled raw material and the second recycled raw material different from the first recycled raw material, a laminated film including a layer configured by the first recycled raw material and a layer configured by the second recycled raw material, in other words, a laminated film including different raw materials, can be used as the recycled raw material for the core layer 20. Further, thermoplastic resins contained in packaging materials recovered from the market often include polyester-based resin and polystyrene-based resin mixed without being separated. Since specific gravities of these resins are greater than 1, separation depending on the specific gravity is unfeasible. However, according to the heat shrinkable film 10, even in the case of including polyester-based resin and polystyrene-based resin being mixed, these resins can be used as the recycled raw material through mechanical recycling, without separation.

As described above, the heat shrinkable film 10 including the core layer 20 including the recycled raw material and the surface layer 30 substantially configured by the virgin raw material can be appealed as a film that reduces the burden on the environment through, for example, resource circulation rate. Especially, in the case of using environmental-load reducing materials such as the above-described chemical recycle raw materials and biomass raw materials for the surface layer 30 and configuring the core layer 20 solely by recycled raw materials, it can be appealed as resource circulation rate 100% or environmental-load reduction rate 100%.

### 2. Second Embodiment

A heat shrinkable film 10X of a second embodiment includes a core layer 20X and a surface layer 30X. The second embodiment is different from the first embodiment in this point, but is similar to the first embodiment in the rest of configuration. Hereinafter, the heat shrinkable film 10X of the second embodiment will be described mainly with respect to differences in features from the first embodiment.

### <2-1. Configuration of Heat Shrinkable Film>

FIG. 2 is a cross-sectional diagram illustrating an exemplary layer configuration of the heat shrinkable film 10× of the second embodiment. The heat shrinkable film 10× includes the core layer 20× and the surface layer 30× layered on at least one surface of the core layer 20×. When a recycled raw material is included in surface layers of heat shrinkable films, film surfaces may be roughened, and glossiness and printing characteristics or the like may deteriorate. The heat shrinkable film 10× of the present embodiment is configured in such a manner that, even when the surface layer 30× is configured to include a recycled raw material, the film surfaces are less likely to be roughened while high quality is maintained.

### <2-2. Configuration of Core Layer>

In the present embodiment, the core layer 20× is substantially configured solely by a virgin raw material (in other words, the virgin raw material is a main component). For example, an arbitrary thermoplastic resin exemplified for the core layer 20 of the heat shrinkable film 10 in the first embodiment can be used for the virgin raw material for the core layer 20×. In the present embodiment, the virgin raw material for the core layer 20× is polystyrene-based resin. As described above, the virgin raw material may be petroleum-derived raw materials, or environmental-load reducing raw materials, or may be both of them.

### <2-3. Configuration of Surface Layer>

The surface layer 30× includes a virgin raw material and a recycled raw material. The virgin raw material for the surface layer 30× is different from the virgin raw material for the core layer 20×. An arbitrary thermoplastic resin exemplified for the surface layer 30 of the heat shrinkable film 10 in the first embodiment can be used as the virgin raw material for the surface layer 30×. In the present embodiment, the virgin raw material for the surface layer 30× is polyester-based resin. As described above, the virgin raw material may be petroleum-derived raw material or environmental-load reducing raw material, or may be both of them.

The recycled raw material for the surface layer 30× of the second embodiment includes third recycled raw material and fourth recycled raw material that is different from the third recycled raw material. Here, the differences in recycled raw materials is the same as described in the first embodiment. From the viewpoint of further improving the quality of the heat shrinkable film 10×, the third recycled raw material is preferably the same raw material as the virgin raw material for the surface layer 30×. In the present embodiment, the third recycled raw material is polyester-based resin and the fourth recycled raw material is polystyrene-based resin.

Proportion RY of the recycled raw materials to the entire thermoplastic resin of the surface layer 30× is equal to or less than 25 wt. %, from the viewpoint of suppressing the occurrence of surface roughness in the surface layer 30×.

Proportion RB of the fourth recycled raw material to the recycled raw material (third recycled raw material+fourth recycled raw material) in the entire thermoplastic resin of the surface layer 30× is arbitrarily selectable. When the third recycled raw material is the same raw material as the virgin raw material for the surface layer 30×, from the viewpoint of improving the quality of the heat shrinkable film 10×, the proportion RB is preferably equal to or less than 15 wt. %.

### <2-4. Functions and Effects of Heat Shrinkable Film>

According to the heat shrinkable film 10×, since the surface of the core layer 20× is covered with the surface layer 30× whose proportion RY is low, optical properties and the like are unlikely to deteriorate. Therefore, even in the case of using the recycled raw material, the quality of the heat shrinkable film 10× is high.

Further, since the recycled raw material for the surface layer 30× includes the third recycled raw material and the fourth recycled raw material that is different from the third recycled raw material, a laminated film including a layer configured by the third recycled raw material and a layer configured by the fourth recycled raw material, in other words, a laminated film including different raw materials, can be used as the recycled raw material for the surface layer 30×. Especially, thermoplastic resins contained in packaging materials recovered from the market often include polyester-based resin and polystyrene-based resin mixed without being separated. Since specific gravities of these resins are greater than 1, separation depending on the specific gravity is unfeasible. However, according to the heat shrinkable film 10, even in the case of containing polyester-based resin and polystyrene-based resin being mixed, these resins can be used as the recycled raw material through mechanical recycling, without separation.

### <3. Heat Shrinkable Film Manufacturing Method>

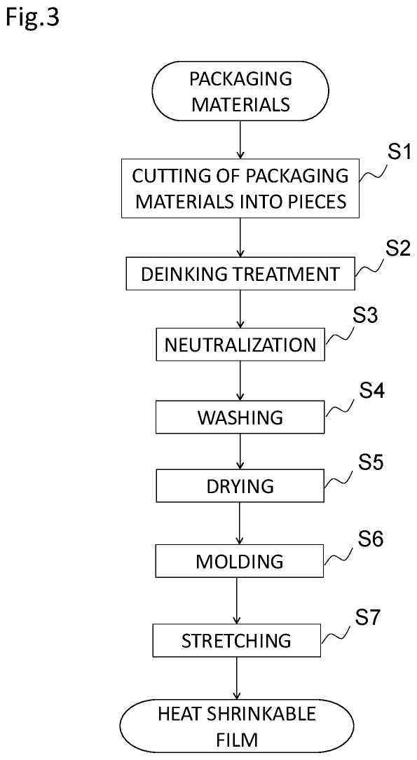

FIG. 3 is a flowchart illustrating the flow of a method for manufacturing the heat shrinkable film 10 using the packaging materials as a starting material. Hereinafter, the method for manufacturing the heat shrinkable film 10 will be described with reference to FIG. 3.

First, packaging materials serving as the starting material for manufacturing the heat shrinkable film 10 are prepared. The packaging materials include a plurality of film labels mainly recovered from the market. These film labels have a resin layer including thermoplastic resin as a main component and a print layer configured by inks layered on the resin layer. The resin layers of the film labels of the present embodiment include at least polystyrene-based resin and polyester-based resin. The film labels may include a mixture of polystyrene-based resin and polyester-based resin in one resin layer. In addition, at least some film labels may have overcoat layers configured by an overcoat agent. Further, the film labels may be heat shrinkable or not heat shrinkable. The packaging materials may include, in addition to these film labels, other packaging materials, such as films mainly containing polystyrene-based resin, polyester-based resin, and mixture resins thereof.

Subsequently, each of the above-described packaging materials is cut into chips as individual pieces (step S1). Methods for cutting the packaging materials are not particularly limited, and can be performed using a known slitter, shredder, pulverizer, cutting machine, or the like. Individual pieces of the packaging materials thus obtained are also referred to as fluff. Although the fluff is not particularly limited in size, it is preferably in a size that can be supplied to an extruder.

Subsequently, deinking treatment is performed to separate the print layer from the resin layer of the above-described fluff, thereby obtaining pieces of the resin layer from which the print layer has been removed (hereinafter, also referred to as “deinked fluff”) (step S2). Deinking treatment methods are not particularly limited, and a known method can be used. More specifically, as disclosed in Japanese Patent Application Laid-Open No. 11-333952 or the like, a method for removing the print layer by immersing the fluff into alkaline aqueous solution can be used. Here, the overcoat layer is also separated from the resin layer to some extent and is removed from the resin layer.

The deinked fluff obtained in step S2 includes polystyrene-based resin and polyester-based resin. Further, a trace amount of acrylic acid (methacrylic acid) ester-based resin derived from the overcoat agent may remain in the above-described deinked fluff.

Subsequently, the deinking fluff obtained in step S2 is immersed in an acid aqueous solution to neutralize the alkalinity (step S3). Although the acid aqueous solution is not particularly limited, acetic acid aqueous solution can be used, for example. When the alkaline aqueous solution is used in step S2, providing this step S3 makes it possible to save the amount of water used in a washing process described below.

Subsequently, the deinked fluff is washed with water to wash away at least either the alkaline aqueous solution or the acid aqueous solution adhering to the deinked fluff (step S4).

Subsequently, the washed deinked fluff is dried to remove the water remaining (step S5). This can suppress thermal decomposition and deterioration of the thermoplastic resin when the deinked fluff is fed to the extruder for melt kneading or when re-pellets are manufactured from the deinked fluff. The drying method is not particularly limited, and a hot air dryer, a vacuum dryer, and a blower can be used to perform the drying. The drying temperature is preferably not higher than a temperature at which the thermoplastic resin included in the deinked fluff (in the present embodiment, polystyrene-based resin and polyester-based resin) does not weld.

Subsequently, the deinked fluff obtained in step S5 is included in the raw materials for the core layer 20, and then a resin-based film including the core layer 20 and the surface layer 30 is molded (step S6). More specifically, the deinked fluff obtained in step S5 and other raw materials are fed to the extruder, melted and kneaded, and a resin-based film in which at least the core layer 20 and the surface layer 30 are layered is extruded. The extrusion molding may be coextrusion of the core layer 20 and the surface layer 30. In the present embodiment, the coextrusion is performed so that respective surface layers 30 are layered on both surfaces of the core layer 20. Further, the coextrusion may be performed such that adhesive layers are layered between the core layer 20 and the surface layer 30.

The core layer 20 is formed in step S6 using, as raw materials, polystyrene-based resin serving as the first recycled raw material, polyester-based resin serving as the second recycled raw material, and acrylic acid (methacrylic acid) ester-based resin. Further, the core layer 20 may be formed with a recycled raw material containing raw material other than the packaging materials used as the starting material, such as the above-described manufacturing intermediate materials. Further, the core layer may be formed with raw materials containing the above-described virgin raw material. That is, step S6 may include forming the core layer 20 that further includes a recycled raw material of polystyrene-based resin or polyester-based resin derived from raw materials other than the starting material. In addition or alternatively, this step may include forming the core layer 20 that further includes a virgin raw material of polystyrene-based resin or polyester-based resin.

Step S6 may further include forming the surface layer 30 including the above-described virgin raw material as a main component. In the present embodiment, the surface layer 30 is formed so as to include the virgin raw material of polystyrene-based resin or polyester-based resin. In the present embodiment, the surface layer 30 is formed so that 100% of the thermoplastic resin configuring the surface layer 30 is the virgin raw material of polyester-based resin.

Subsequently, the resin-based film formed in step S6 is cooled and solidified while being wound up with a take-up roll, and then stretched uniaxially or biaxially. Thus, the heat shrinkable film 10 is obtained (step S7).

### 4. Practical Example

### <4-1. Overview>

The inventor(s) of the present application manufactured heat shrinkable films of practical examples, heat shrinkable films of comparative examples, and a heat shrinkable film of reference example, and carried out tests for measuring physical properties of the heat shrinkable films. Table 1 is a table illustrating specifications about heat shrinkable films of practical examples 1 to 6, heat shrinkable film of comparative example 1, and heat shrinkable film of the reference example. Table 2 is a table illustrating specifications about heat shrinkable films of practical examples 7 to 13, and heat shrinkable film of comparative example 2. For convenience of explanation, Table 2 also shows specifications relating to the heat shrinkable film of the same reference example as Table 1. The heat shrinkable film of comparative example 1 has no surface layer. Both the surface layer and the core layer of the heat shrinkable film of comparative example 2 are configured solely by a virgin raw material of polyester-based resin obtained by chemical recycling. Both the surface layer and the core layer of the heat shrinkable film of reference example are configured solely by a petroleum-derived virgin raw material. Practical examples 1 to 4 and 7 to 13 are examples relating to the heat shrinkable film 10 of the first embodiment. Practical examples 5 and 6 are examples relating to the heat shrinkable film 10× of the second embodiment. In the heat shrinkable films of practical examples 1 to 13, the surface layer is layered on both surfaces of the core layer.

### <4-2. Virgin Material>

Specifications of virgin raw materials used for the heat shrinkable films of practical examples, comparative examples, and reference example are as follows.

### <4-2-1. Petroleum-derived Polyester-Based Resin>

The virgin raw material of petroleum-derived polyester-based resin includes 100 mol % of a component derived from terephthalic acid as dicarboxylic acid components, 65 mol % of a component derived from ethylene glycol, 20 mol % of a component derived from diethylene glycol, and 15 mol % of a component derived from 1,4-cyclohexanedimethanol, as diol components. The glass transition temperature thereof is 70° C.

### <4-2-2. Chemical Recycle Derived Polyester-Based Resin>

The virgin raw material of chemical recycle derived polyester-based resin is ECOTRIA R100 (manufactured by SK Chemicals Co., Ltd.). The under-load deflection temperature of the virgin raw material based on ISO 75 at 0.455 MPa is 72° C.

### <4-2-3. Petroleum-derived Polystyrene-Based Resin>

The virgin raw material of petroleum-derived polystyrene-based resin is styrene-butadiene copolymer. The styrene-butadiene copolymer includes styrene content by 81.3 wt. % and butadiene content by 18.7 wt. %. Vicat softening temperature thereof is 80° C.

### 4-3. Manufacturing Method of Reference Example

A heat shrinkable film manufacturing method of the reference example is as follows. First, the raw materials listed in Table 1 are used as raw materials configuring the core layer and the surface layer, and put into an extruder with a barrel temperature of 160 to 250° C., and then extruded into a 3-layered sheet from a multilayer die at 210° C. and cooled and solidified using a take-up roll at 30° C. Next, stretching is performed at stretching ratio of 6 times in a tenter drawing machine with a preheating zone of 105° C., a stretching zone of 89 to 91° C., and a heat fixing zone of 85° C. Then, winding-up is performed with a winder, thereby obtaining a heat shrinkable film in which the direction normal to the main shrinkage direction is MD (Machine Direction) and the main shrinkage direction is TD (Transverse Direction).

### 4-4. Method for Manufacturing Recycled Raw Materials of Practical Example and Comparative Examples

A method for manufacturing recycled raw materials for the practical examples and the comparative examples is as follows. A print layer is layered on one surface of the heat shrinkable film of reference example, using a photogravure printing machine. Further, an overcoat layer is layered on the other surface of the heat shrinkable film of reference example by applying an acrylic acid (methacrylic acid) ester-based resin. Next, the heat shrinkable film having the print layer is processed into chips using a pulverizer, subjected to deinking treatment to obtain deinked fluff, and dried with hot air, thereby manufacturing recycled raw materials for the practical examples and the comparative examples. The deinked fluff included in raw materials for the core layers of practical examples 7, 8, 12, and 13 is configured by 40 wt. % of polystyrene and 60 wt. % of polyester. The deinked fluff included in raw materials for the core layers of practical examples 9 to 11 is configured by 20 wt. % of polystyrene and 80 wt. % of polyester. Further, recycled raw materials for the core layer of practical example 12 include, in addition to the above-described deinked fluff, a recycled raw material derived from manufacturing intermediate materials generated in manufacturing processes of the heat shrinkable film of reference example. The proportion of the recycled raw material derived from the manufacturing intermediate materials to the entire thermoplastic resin configuring the core layer of practical example 12 was 70 wt. %. Further, the proportion of the polyester-based resin in the recycled raw material derived from the manufacturing intermediate materials was 30 wt. %.

### 4-5. Method for Manufacturing Heat Shrinkable Films of Practical Example and Comparative Example

Manufacturing methods of heat shrinkable films of practical examples 1 to 13, and comparative examples 1 to 2 are as follows. The raw materials listed in Table 1 and Table 2 are used as raw materials configuring the core layer and the surface layer. Then, mixing of these materials is performed in the proportions shown in Table 1 and Table 2, thereby obtaining raw material compositions configuring the core layer and the surface layer according to the practical examples 1 to 13 and comparative examples 1 to 2. Using these raw material compositions, the heat shrinkable films of practical examples 1 to 13 and comparative examples 1 to 2 have been manufactured in the same manner as the heat shrinkable film of the reference example. A content rate of acrylic acid (methacrylic acid) ester-based resin derived from the overcoat layer (a proportion thereof to the entire thermoplastic resin configuring each heat shrinkable film) was calculated based on the area of the signal derived from the side chain of polymethyl methacrylate in 1H-NMRspectrum obtained by NMR measurement of each heat shrinkable film.

TABLE 1

| | | Used Raw | Example | Example | Example | Example | Example | Example | Comparative | Reference |
|---|---|---|---|---|---|---|---|---|---|---|
| | | Materials | 1 | 2 | 3 | 4 | 5 | 6 | Example 1 | Example |
| Configuration | Surface | Virgin Raw | 100 | 100 | 100 | 100 | 95 | 80 | — | 100 |
| | Layer | Material | | | | | | | | |
| | | (Polyester- | | | | | | | | |
| | | Based Resin) | | | | | | | | |
| | | [wt. %] | | | | | | | | |
| | | Recycled | — | — | — | — | 5 | 20 | — | — |
| | | Raw | | | | | | | | |
| | | Material | | | | | | | | |
| | | (Polyester- | | | | | | | | |
| | | Based Resin | | | | | | | | |
| | | and | | | | | | | | |
| | | Polystyrene- | | | | | | | | |
| | | Based Resin) | | | | | | | | |
| | | [wt. %] | | | | | | | | |
| | Core | Virgin Raw | 95 | 90 | 80 | 65 | 100 | 100 | 80 | 100 |
| | Layer | Material | | | | | | | | |
| | | (Polystyrene- | | | | | | | | |
| | | Based Resin) | | | | | | | | |
| | | [wt. %] | | | | | | | | |
| | | Recycled | 5 | 10 | 20 | 35 | — | — | 20 | — |
| | | Raw | | | | | | | | |
| | | Material | | | | | | | | |
| | | (Polystyrene- | | | | | | | | |
| | | Based Resin | | | | | | | | |
| | | and | | | | | | | | |
| | | Polyester- | | | | | | | | |
| | | Based Resin) | | | | | | | | |
| | | [wt. %] | | | | | | | | |
| | Thickness | Surface | 5 | 5 | 5 | 5 | 5 | 5 | — | 5 |
| | | Layer | | | | | | | | |
| | | Thickness | | | | | | | | |
| | | [μm] | | | | | | | | |
| | | Core Layer | 25 | 25 | 25 | 25 | 25 | 25 | 35 | 25 |
| | | Thickness | | | | | | | | |
| | | [μm] | | | | | | | | |
| | | Surface | 5 | 5 | 5 | 5 | 5 | 5 | — | 5 |
| | | Layer | | | | | | | | |
| | | Thickness | | | | | | | | |
| | | [μm] | | | | | | | | |
| | | Total | 35 | 35 | 35 | 35 | 35 | 35 | 35 | 35 |
| | | Thickness | | | | | | | | |
| | | [μm] | | | | | | | | |
| | Proportion | Proportion | 1.7 | 3.4 | 6.8 | 11.9 | — | — | — | — |
| | | RA [wt. %] | | | | | | | | |
| | | Proportion | — | — | — | — | 3.3 | 13.2 | — | — |
| | | RB [wt. %] | | | | | | | | |

TABLE 2

| | | Used Raw | Example | Example | Example | Example | Example | Example | Example | Reference | Comparative |
|---|---|---|---|---|---|---|---|---|---|---|---|
| | | Materials | 7 | 8 | 9 | 10 | 11 | 12 | 13 | Example | Example 2 |
| Config- | Surface | Petroleum- | — | — | — | — | — | — | 100 | 100 | — |
| uration | Layer | Derived | | | | | | | | | |
| | | Virgin Raw | | | | | | | | | |
| | | Material | | | | | | | | | |
| | | (Polyester- | | | | | | | | | |
| | | Based Resin) | | | | | | | | | |
| | | [wt. %] | | | | | | | | | |
| | | Chemical | 100 | 100 | 100 | 100 | 100 | 100 | — | — | 100 |
| | | Recycle | | | | | | | | | |
| | | Derived | | | | | | | | | |
| | | Virgin Raw | | | | | | | | | |
| | | Material | | | | | | | | | |
| | | (Polyester- | | | | | | | | | |
| | | Based Resin) | | | | | | | | | |
| | | [wt. %] | | | | | | | | | |
| | Core | Petroleum- | 95 | 70 | 95 | 70 | 20 | — | 95 | 100 | — |
| | Layer | Derived | | | | | | | | | |
| | | Virgin Raw | | | | | | | | | |
| | | Material | | | | | | | | | |
| | | (Polystyrene- | | | | | | | | | |
| | | Based Resin) | | | | | | | | | |
| | | [wt. %] | | | | | | | | | |
| | | Recycled | 5 | 30 | 5 | 30 | 80 | 100 | 5 | — | — |
| | | Raw | | | | | | | | | |
| | | Material | | | | | | | | | |
| | | (Polystyrene- | | | | | | | | | |
| | | Based Resin | | | | | | | | | |
| | | and | | | | | | | | | |
| | | Polyester- | | | | | | | | | |
| | | Based Resin) | | | | | | | | | |
| | | [wt. %] | | | | | | | | | |
| | | Chemical | — | — | — | — | — | — | — | — | 100 |
| | | Recycle | | | | | | | | | |
| | | Derived | | | | | | | | | |
| | | Virgin Raw | | | | | | | | | |
| | | Material | | | | | | | | | |
| | | (Polyester- | | | | | | | | | |
| | | Based Resin) | | | | | | | | | |
| | | [wt. %] | | | | | | | | | |
| | Thickness | Surface | 5 | 5 | 5 | 5 | 5 | 5 | 5 | 5 | 5 |
| | | Layer | | | | | | | | | |
| | | Thickness | | | | | | | | | |
| | | [μm] | | | | | | | | | |
| | | Core Layer | 25 | 25 | 25 | 25 | 25 | 25 | 25 | 25 | 25 |
| | | Thickness | | | | | | | | | |
| | | [μm] | | | | | | | | | |
| | | Surface | 5 | 5 | 5 | 5 | 5 | 5 | 5 | 5 | 5 |
| | | Layer | | | | | | | | | |
| | | Thickness | | | | | | | | | |
| | | [μm] | | | | | | | | | |
| | | Total | 35 | 35 | 35 | 35 | 35 | 35 | 35 | 35 | 35 |
| | | Thickness | | | | | | | | | |
| | | [μm] | | | | | | | | | |
| | Proportion | Core Layer | 3% | 18% | 4% | 24% | 64% | 39% | 3% | 0% | 100% |
| | | Proportion | | | | | | | | | |
| | | RA [wt. %] | | | | | | | | | |
| | | Proportion of | | | | | | | | | |
| | | Polyester- | | | | | | | | | |
| | | Based Resin | | | | | | | | | |
| | | to Recycled | | | | | | | | | |
| | | Raw | | | | | | | | | |
| | | Material in | | | | | | | | | |
| | | Core Layer | | | | | | | | | |
| | | Acrylic | <0.1% | 0.3% | <0.1% | 0.3% | 0.5% | 0.3% | <0.1% | 0% | 0% |
| | | Resin | | | | | | | | | |
| | | Content | | | | | | | | | |
| | | [wt. %] | | | | | | | | | |
| | | (Proportion | | | | | | | | | |
| | | of Overcoat | | | | | | | | | |
| | | Layer | | | | | | | | | |
| | | Derived | | | | | | | | | |
| | | Acrylic | | | | | | | | | |
| | | Resin) | | | | | | | | | |
| | | Proportion of | 11% | 30% | 11% | 30% | 68% | 30% | 4% | 0% | 30% |
| | | Heat | | | | | | | | | |
| | | Shrinkable | | | | | | | | | |
| | | Film Derived | | | | | | | | | |
| | | Recycled | | | | | | | | | |
| | | Raw | | | | | | | | | |
| | | Material | | | | | | | | | |
| | | [wt. %] | | | | | | | | | |

### <5. Test>

The inventor(s) of the present application carried out tests to measure the following items on the heat shrinkable films of practical examples 1 to 13, comparative examples 1 to 2, and reference example.

### <5-1. Wet Heat Shrinkage Rate>

The heat shrinkable films obtained in the practical examples 1 to 13, comparative examples 1 to 2, and reference example were cut into samples with a size of MD 100 mm× TD 100 mm to obtain test pieces. The obtained test pieces were immersed in hot water of 70° C., 80° C., and 90° C. and boiling water (100° C.) for 10 seconds. Then, the test pieces were taken out and immersed in water of 15° C. for 5 seconds. A wet heat shrinkage rate in MD direction was obtained according to the following formula (1), and a wet heat shrinkage rate in TD direction was obtained according to the following formula (2). In the following formula (1), LMD is the length of the test piece after heat shrinkage in the MD direction. In the following formula (2), LTD is the length of the test piece after heat shrinkage in the MD direction. The wet heat shrinkage rate was measured using two test pieces for the heat shrinkable films of each practical example, each comparative example, and reference example, and an average of measurement value was used.

$$\\ \begin{matrix}Wet heat shrinkage rate ( \% ) = \{ ( 100 - {L}_{MD} ) / 100 \} \times 100 & ( 1 )\end{matrix}$$

$$\\ \begin{matrix}Wet heat shrinkage rate ( \% ) = \{ ( 100 - {L}_{TD} ) / 100 \} \times 100 & ( 2 )\end{matrix}$$

### <5-2. Haze>

Haze was measured for the heat shrinkable films of practical examples 1 to 13, comparative examples 1 to 2, and reference example using a haze meter (manufactured by Nippon Denshoku Industries Co., Ltd., NDH5000) according to a method conforming to JIS Z7136. The haze was measured using four test pieces for each practical example, each comparative example, and reference example, and an average of measurement values was calculated.

### <5-3. Glossiness>

Glossiness at incident angle 45° was measured for the heat shrinkable films of each practical example, each comparative example, and reference example using TYPE VG-2000 manufactured by Nippon Denshoku Industries Co., Ltd. according to a method conforming to JIS Z8741.

### <5-4. Impact Strength>

The heat shrinkable films of practical examples 1 to 13, comparative examples 1 to 2, and reference example were cut into samples with a size of MD 100 mm× TD 100 mm to obtain test pieces. The obtained test pieces ware measured using a film impact tester manufactured by Toyo Seiki Seisaku-sho, Ltd. according to a method conforming to JIS P8134. Specifically, the test piece is fixed on a stand. Next, a hook fixing an arm of the film impact tester is released to cause the fan-shaped arm to rotate around its axis so that an impact head attached to a distal end of the arm pierces the test piece. The impact strength is a numerical value obtainable by quantifying the energy required when the impact head pierces the test piece. Measurement of the impact strength was performed five times to obtain an average value thereof.

### <5-5. Compressive Strength>

Compressive strength was measured for the heat shrinkable films of practical examples 1 to 13, comparative examples 1 to 2, and reference example according to a method conforming to JIS P8126. Specifically, the following method was used. The obtained heat shrinkable films were cut into strips which are 152.4 mm in length and 12.7 mm in width, and cylindrically set on a prefabricated support. Then, the support is placed on a frame of a ring crash tester (manufactured by Toyo Seiki Seisaku-sho, Ltd. TYPE D) to carry out measurement. The measurement was performed only for the compressive strength in the vertical direction (film flow direction), and an average of measurement values was obtained as n=8.

### <5-6. Young's Modulus>

The heat shrinkable films of practical examples 1 to 13, comparative examples 1 to 2, and reference example were cut into samples with a size of MD 250 mm×TD 5 mm to obtain test pieces. The obtained test pieces were measured using STROGRAPH VE-1D manufactured by Toyo Seiki Seisaku-sho, Ltd. according to a method conforming to ASTM D882. Measurement of Young's modulus was performed using four test pieces for each practical example, each comparative example, and reference example, and an average of measurement values was calculated.

### <5-7. Surface Roughness>

The heat shrinkable films of practical examples 1 to 6, comparative example 1, and reference example were set in SURFCOM 570A manufactured by Tokyo Seimitsu Co., Ltd., and Ra (arithmetic mean roughness), Rmax (maximum height roughness), and Rz (ten-point average roughness) were measured in conformity to ISO13565-1 standards. Measurement conditions are as follows.
Cutoff: 0.8 mm
Driving speed of measurement terminal: 0.3 mm/see
Measurement length: 20.0 mm
Measurement magnification: vertical magnification×10,000, and horizontal magnification×5

### <5-8. Natural Shrinkage Rate>

Three samples with a size of MD 100 mm×TD 100 mm were cut out from arbitrary portions of each of the heat shrinkable films of practical examples 7 to 13, comparative example 1, and reference example. After each sample was left to stand for 7 days in a low-temperature incubator (IL-82 manufactured by Yamato Scientific Co., Ltd.) adjusted to a constant temperature, length LMD (mm) in the MD direction and length LTD (mm) in the TD direction were measured for each sample. Temperature conditions were 30° C. and 40° C. Average values of natural shrinkage rate (%) for respective samples in the MD direction and the TD direction were calculated according to the above-described formulae (1) and (2).

### <6. Test Results>

Table 3 is a table illustrating test results of the practical examples 1 to 6, comparative example 1, and reference example. The test results of the heat shrinkable films of practical examples 1 to 5 are approximately the same as those of the heat shrinkable film of reference example in respective measurement items. Further, the heat shrinkable film of practical example 6 is lightly higher in haze than that of the heat shrinkable film of reference example and is slightly lower in glossiness than that of the heat shrinkable film of reference example. However, in the remaining measurement items, obtained test results are approximately the same as those of the heat shrinkable film of reference example. In respective heat shrinkable films of practical examples 1 to 4, the surfaces of the core layers containing the recycled raw materials are covered with the surface layers substantially configured solely by the virgin raw material. In the heat shrinkable films of practical examples 5 and 6, the surfaces of the core layers are covered with the surface layers that are lower in proportion RY. Therefore, it is considered that the heat shrinkable films of the above practical examples have physical properties similar to those of the heat shrinkable film of reference example. On the other hand, regarding respective measurement items, the heat shrinkable film of comparative example is higher in haze than the heat shrinkable film of reference example and is lower in glossiness than the heat shrinkable film of reference example. The reason why the heat shrinkable film of comparative example is deteriorated in glossiness is believed because the core layer contains the recycled raw materials that are different from the virgin raw materials.

TABLE 3

| | | | | | Example | Example | Example | Example | Example | Example | Comparative | Reference |
|---|---|---|---|---|---|---|---|---|---|---|---|---|
| | Item | | Condition | Units | 1 | 2 | 3 | 4 | 5 | 6 | Example 1 | Example |
| Physical | Wet Heat | MD/TD | 70° C. | % | −4/41 | −3/41 | −3/41 | −3/39 | −4/40 | −3/38 | −3/41 | −4/41 |
| Prop- | Shrinkage | | 80° C. | % | −4/60 | −4/60 | −2/60 | −3/57 | −4/59 | −6/58 | −4/60 | −3/60 |
| erties | Rate (10 s) | | 90° C. | % | 0/70 | 1/70 | 1/69 | 0/67 | 2/69 | 3/68 | 1/71 | 2/70 |
| | | | 100° C. | % | 7/75 | 7/75 | 8/75 | 5/74 | 7/75 | 7/74 | 7/76 | 5/74 |
| | Haze | | | % | 7.26 | 7.14 | 7.55 | 6.74 | 6.32 | 8.05 | 9.73 | 5.95 |
| | Glossiness | | | % | 172.7 | 172.9 | 172.3 | 165.6 | 171.4 | 149 | 110 | 173.4 |
| | Impact | | | J | 0.81 | 0.96 | 1.21 | 0.98 | 0.88 | 0.87 | 0.85 | 0.81 |
| | Strength | | | | | | | | | | | |
| | Compressive | | | N | 3.09 | 3.41 | 3.36 | 3.3 | 3.12 | 3.05 | 2.74 | 3.11 |
| | Strength | | | | | | | | | | | |
| | Young's | MD/TD | | Gpa | 1.4/2.6 | 1.5/2.5 | 1.5/2.9 | 1.6/3.0 | 1.4/2.5 | 1.3/2.0 | 1.2/1.8 | 1.4/2.5 |
| | Modulus | | | | | | | | | | | |
| | Surface | Ra | | μm | 0.10 | 0.09 | 0.10 | 0.07 | 0.08 | 0.09 | 0.10 | 0.08 |
| | Roughness | | | | | | | | | | | |
| | | Rmax | | μm | 4.22 | 3.75 | 4.52 | 3.44 | 3.88 | 3.84 | 3.98 | 4.13 |
| | | Rz | | μm | 1.98 | 1.78 | 2.51 | 1.62 | 2.34 | 2.20 | 2.05 | 1.82 |

Table 4 is a table illustrating test results of practical examples 7 to 13, comparative example 2, and reference example. The heat shrinkable films of practical examples 7 and 13 were substantially similar to the heat shrinkable film of reference example and exhibited good properties even through the recycled raw materials are contained. From the results of practical examples 7 and 13, it was confirmed that there is no problem when the virgin raw material for the surface layer is a chemical recycle derived recycled raw material or a petroleum-derived virgin raw material. It was confirmed that the heat shrinkable films of practical examples 8, 10, and 12 were within a range in which no problem occurs in practical use, although there is a tendency of being higher in haze, compressive strength, and Young's modulus compared with the heat shrinkable film of reference example. It was confirmed that the heat shrinkable film of practical example 9 is within a range in which no problem occurs in practical use because, although the haze was higher compared to the heat shrinkable film of reference example, there is no substantial difference from the heat shrinkable film of reference example in the remaining physical properties. It was confirmed that the heat shrinkable film of practical example 11 is better than that of comparative example 2 and is usable as a low heat shrinkable film, although in comparison with the heat shrinkable film of reference example it is higher in haze, compressive strength, and Young's modulus and is lower in heat shrinkable properties. Note that the higher the impact strength, compressive strength, and Young's modulus, the higher the strength of the heat shrinkable film. On the other hand, it means that when these values are higher the shape followability during heat shrinkage is lower.

TABLE 4

| | | | | | Example | Example | Example | Example | Example |
|---|---|---|---|---|---|---|---|---|---|
| | Item | | Condition | Units | 7 | 8 | 9 | 10 | 11 |
| Physical | Wet Heat | MD/TD | 70° C. | % | −2/40 | −2/40 | −3/41 | −3/39 | 0/25 |
| Properties | Shrinkage | | 80° C. | % | −1/60 | −1/59 | −3/61 | −3/60 | −1/49 |
| | Rate (10 s) | | 90° C. | % | 2/69 | −1/70 | 1/70 | 0/69 | 3/60 |
| | | | 100° C. | % | 4/75 | 6/75 | 5/75 | 8/75 | 5/70 |
| | Natural | MD/TD | 30° C. | % | 0.0/0.1 | 0.0/0.1 | 0.0/0.1 | 0.0/0.2 | 0.0/0.1 |
| | Shrinkage | | 40° C. | % | 0.0/0.8 | 0.0/1.0 | 0.0/0.9 | 0.0/0.8 | 0.0/0.5 |
| | Rate (1 W) | | | | | | | | |
| | Haze | | | % | 5.8 | 6.5 | 9.7 | 19.5 | 7.1 |
| | Glossiness | | | % | 172.4 | 170.5 | 171.7 | 166.5 | 164.2 |
| | Impact | | | J | 0.8 | 0.94 | 0.77 | 1.01 | 1.05 |
| | Strength | | | | | | | | |
| | Compressive | | | N | 3.01 | 3.34 | 3.05 | 3.37 | 4.12 |
| | Strength | | | | | | | | |
| | Young's | MD/TD | | Gpa | 1.5/2.5 | 1.6/3.1 | 1.4/2.5 | 1.5/3.1 | 1.7/4.2 |
| | Modulus | | | | | | | | |

| | | | | | Example | Example | Reference | Comparative |
|---|---|---|---|---|---|---|---|---|
| | Item | | Condition | Units | 12 | 13 | Example | Example 2 |
| Physical | Wet Heat | MD/TD | 70° C. | % | −1/34 | −1/40 | −4/41 | 4/20 |
| Properties | Shrinkage | | 80° C. | % | 0/55 | −2/60 | −3/60 | 2/47 |
| | Rate (10 s) | | 90° C. | % | 2/64 | 1/70 | 2/70 | 5/47 |
| | | | 100° C. | % | 7/72 | 5/75 | 5/74 | 5/67 |
| | Natural | MD/TD | 30° C. | % | 0.0/0.2 | 0.0/0.1 | 0.0/0.2 | 0.0/0.1 |
| | Shrinkage | | 40° C. | % | 0.0/0.7 | 0.0/0.8 | 0.0/0.8 | 0.0/0.2 |
| | Rate (1 W) | | | | | | | |
| | Haze | | | % | 8.4 | 6.2 | 5.9 | 4.5 |
| | Glossiness | | | % | 166.7 | 170.5 | 173.4 | 166.5 |
| | Impact | | | J | 1.07 | 0.84 | 0.81 | 1.1 |
| | Strength | | | | | | | |
| | Compressive | | | N | 3.75 | 3.07 | 3.11 | 5.2 |
| | Strength | | | | | | | |
| | Young's | MD/TD | | Gpa | 1.6/3.5 | 1.4/2.6 | 1.4/2.5 | 2.1/5.4 |
| | Modulus | | | | | | | |

### 7. Modified Embodiment

Each of the above-described embodiments is an exemplary form that the heat shrinkable film according to the present invention can take, and is not intend to limit the form. The heat shrinkable film according to the present invention may take a form different from the form illustrated in each embodiment. An example thereof is a form in which a part of the configuration of each embodiment is replaced, changed, or omitted, or a form in which a new configuration is added to each embodiment. Some exemplary modifications of respective embodiments will be described below.

<7-1>

In the first embodiment, the first recycled raw material for the core layer 20 is the same raw material as the virgin raw material for the core layer 20. However, the first recycled raw material may be a raw material different from the virgin raw material for the core layer 20. That is, in this modified embodiment, the virgin raw material for the core layer 20, the first recycled raw material, and the second recycled raw material are raw materials different from each other.

<7-2>

In the first embodiment, the recycled raw material for the core layer 20 includes the first recycled raw material and the second recycled raw material. However, the recycled raw material for the core layer 20 may be only the first recycled raw material. In this modified embodiment, the first recycled raw material may be the same raw material as the virgin raw material for the core layer 20 or may be raw material different from the virgin raw material for the core layer 20.

<7-3>

In the second embodiment, the core layer 20× substantially includes only the virgin raw material. However, like the first embodiment, the core layer 20× may include the recycled raw material.

<7-4>

In the second embodiment, the third recycled raw material for the surface layer 30× is the same raw material as the virgin raw material for the surface layer 30×. However, the third recycled raw material may be a raw material different from the virgin raw material for the surface layer 30×. That is, in this modified embodiment, the virgin raw material for the surface layer 30×, the third recycled raw material, and the fourth recycled raw material are different from each other.

<7-5>

In the second embodiment, the recycled raw material for the surface layer 30× includes the third recycled raw material and the fourth recycled raw material. However, the recycled raw material for the surface layer 30× may be only the third recycled raw material. In this modified embodiment, the third recycled raw material may be the same raw material as the virgin raw material for the surface layer 30× or may be a raw material different from the virgin raw material for the surface layer 30×.

<7-6>

The order of steps S1 to S5 in the above-described embodiment may be changed. For example, neutralization, washing, drying, and the like may be performed, if necessary, after performing the deinking treatment for separating the print layers from the packaging materials. Subsequently, the resin layers of the packaging materials from which the print layers have been removed may be cut into pieces to obtain the deinked fluff. Further, at least one of cutting, neutralization, washing, and drying may be appropriately omitted, or may be performed two times or more if necessary. Moreover, the recycled raw material may be used in step S6 after completing a step of being pelletized, instead of in the form of fluff.

<7-7>

In step S6 of the above-described embodiment, the heat shrinkable film 10× can be manufactured by forming a resin-based film including the core layer 20× and the surface layer 30×, in which the raw materials for the surface layer 30× include the deinked fluff obtained in step S5. Similar to the core layer 20 of the above-described embodiment, the surface layer 30× is formed in step S6, using, as raw materials, polystyrene-based resin serving as the third recycled raw materials, polyester-based resin serving as the fourth recycled raw materials, and acrylic acid (methacrylic acid) ester-based resin. Further, the surface layer 30× may be formed with raw materials containing recycled raw materials derived from the above-described manufacturing intermediate materials. Further, the surface layer 30× and the core layer 20× may be formed with raw materials containing the above-described virgin raw materials.

<7-8>

When a pair of the first recycled raw material and the second recycled raw material is a combination of polystyrene-based resin and polyester-based resin, the first recycled raw material may be polyester-based resin and the second recycled raw material may be polystyrene-based resin. Further, when a pair of the third recycled raw material and the fourth recycled raw material is a combination of polystyrene-based resin and polyester-based resin, the third recycled raw material may be polystyrene-based resin and the fourth recycled raw material may be polyester-based resin. Further, in the first embodiment, the virgin raw material for the surface layer 30 may be polystyrene-based resin. In this case, the proportion of the above-described polystyrene-based resin to the entire thermoplastic resin is preferably equal to or greater than 85 wt. %, more preferably equal to or greater than 90 wt. %, and further preferably equal to or greater than 95 wt. %. Setting the proportion of the above-described polystyrene-based resin to be equal to or greater than the above-described lower limit can suppress the natural shrinkage rate of the heat shrinkable film 10 to be lower and can improve heat-resisting properties and chemical resistant properties.

### REFERENCE SIGNS LIST

10, 10×: heat shrinkable film
20, 20×: core layer
30, 30×: surface layer

1. A manufacturing method for a heat shrinkable film comprising:
preparing packaging materials including a plurality of film labels having a resin layer including thermoplastic resin as a main component and a print layer:
recovering, from the resin layer, a first recycled raw material and a second recycled raw material that is different from the first recycled raw material; and
forming a resin-based film having at least a core layer including at least the first recycled raw material and the second recycled raw material and a surface layer layered on the core layer and containing thermoplastic resin,
wherein the recovering the first recycled raw material and the second recycled raw material includes:
cutting at least either the packaging materials or the resin layer from which the print layer has been removed into pieces; and
separating the print layer from at least either the packaging materials or the pieces of the packaging materials, thereby obtaining at least either the resin layer from which the print layer has been removed or the pieces of the resin layer from which the print layer has been removed, and
one of the first and second recycled raw materials is polyester-based resin and the other is polystyrene-based resin.

2. The manufacturing method for a heat shrinkable film according to claim 1, wherein the forming the resin-based film includes forming the surface layer mainly containing a virgin raw material of thermoplastic resin, and the thermoplastic resin is polyester-based resin or polystyrene-based resin.

3. The manufacturing method for a heat shrinkable film according to claim 1, further comprising recovering the polystyrene-based resin from a manufacturing intermediate material other than the packaging materials,
wherein the forming the resin-based film includes forming the core layer including the recovered polystyrene-based resin.

4. The manufacturing method for a heat shrinkable film according to claim 2, further comprising recovering the polystyrene-based resin from a manufacturing intermediate material other than the packaging materials,
wherein the forming the resin-based film includes forming the core layer including the recovered polystyrene-based resin.

5. A heat shrinkable film comprising:
a core layer including at least a first recycled raw material, a second recycled raw material that is different from the first recycled raw material, and an acrylic ester-based resin; and
a surface layer layered on at least one surface of the core layer and including thermoplastic resin,
wherein the first recycled raw material is obtained from packaging materials serving as starting materials and including a plurality of film labels having a resin layer including thermoplastic resin as a main component and a print layer; and
one of the first and second recycled raw materials is polyester-based resin and the other is polystyrene-based resin.
